(19) United States
(12) Patent Application Publication
(10) Pub. No.: US 2008/0162838 A1
(43) Pub. Date: Jul. 3, 2008

(54) APPARATUS AND METHOD FOR FIRMWARE UPGRADE

(75) Inventors: Jung-Min CHO, Seoul (KR); Gyo-Chan Song, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/969,033

(22) Filed: Jan. 3, 2008

(30) Foreign Application Priority Data
Jan. 3, 2007 (KR) 2007-0000508

(51) Int. Cl. G06F 13/14

(52) U.S. Cl. 711/159

(57) ABSTRACT

An apparatus and method for firmware upgrade in a portable terminal is provided. A memory access method for the firmware upgrade in the portable terminal includes the steps of receiving data and a write request signal of the data from an upper layer, compressing the data, and when the capacity of the compressed data is greater than that of a first area of a memory, separating and storing the data in the first area and a second area.

### PRIORITY

This application claims priority under 35 U.S.C. § 119 to an application filed in the Korean Intellectual Property Office on Jan. 3, 2007 and assigned Serial No. 2007-0000508, the contents of which are incorporated herein by reference.

### BACKGROUND OF THE INVENTION

1. Field of the Invention

The present invention relates generally to firmware upgrade, and in particular, to an apparatus and method that can compress and decompress data stored in a memory using a virtual driver to reduce a necessary capacity of the memory.

2. Description of the Related Art

As performance of a portable terminal is developed, software of the portable terminal becomes more and more complicated with the increase of their functions. Bug-free software is realistically impossible to achieve in the final stages of production of the portable terminal due to the complicated software. Accordingly, after a consumer buys the portable terminal, a manufacturer supplies patch software to upgrade firmware of the portable terminal.

However, the consumer must take the portable terminal to an After Service (A/S) center in order to upgrade the firmware. Hence, it is difficult to ensure the timely upgrade of the firmware. To solve this problem, a standard for downloading a software binary for the upgrade through a network to safely upgrade the firmware has been established. This technology is called a “Firmware Over The Air (FOTA)”. FOTA technology is being introduced in an up-to-date portable terminal.

FIG. 1 is a block diagram of a conventional firmware upgrade method.

Referring to FIG. 1, a FOTA engine 110 accesses a memory 150 using a software driver 140 to upgrade firmware.

FOTA technology uses a delta between two software binary values, i.e., a delta between a software binary value before performing upgrade and a software binary value after performing upgrade. That is, the delta is transmitted to a portable terminal through a network, and the portable terminal receives the delta to upgrade firmware thereof.

To safely perform the upgrade, the delta must be transmitted through the network without any errors. In addition, spaces for temporarily storing the delta must be distributed in the portable terminal. A maximum value of the delta is limited by manufacturers. It is important to maintain the delta as small as possible when the upgrade is performed using FOTA technology.

However, a limitation of FOTA technology is that an auxiliary memory for storing the delta is required. In the application of FOTA technology, an auxiliary space (also referred to as a “hole”) of about 10-15% of initial software binary is required in preparation for modification of the software binary. This method is applied when the first software binary is fabricated to increase a size of the software binary by about 10-15%. Therefore, the fabrication cost increases due to the increase in memory capacity.

In addition, a further limitation of FOTA technology is that it is difficult to compress the software binary. Accordingly, the space occupied by the software binary decreases to reduce the fabrication cost, but the compression of the software binary is not considered. Even if the compression of the software binary is applied, the delta between two software binary values is greatly increased to the point where it lacks practicality.

Since the memory capacity increases by about 10-15% and the compression of the software binary is applied for using FOTA technology, the memory capacity about twice as large as the compression of the software binary in which FOTA technology is not applied is required, thereby increasing the fabrication cost.

### SUMMARY OF THE INVENTION

An object of the present invention is to substantially solve at least the above problems and/or disadvantages and to provide at least the advantages below. Accordingly, an object of the present invention is to provide an apparatus and method for firmware upgrade.

Another object of the present invention is to provide an apparatus and method for firmware upgrade in a portable terminal by improving a FOTA technology and applying compression to reduce memory capacity.

According to one aspect of the present invention, a memory access method for firmware upgrade in the portable terminal includes receiving data and a write request signal of the data from an upper layer, compressing the data, and when the capacity of the compressed data is greater than that of a first area of a memory, separating and storing the data in the first area and a second area.

According to another aspect of the present invention, a memory access method for firmware upgrade in a portable terminal includes receiving a read request signal of data from an upper layer, calculating a position of the data, loading the data corresponding to the calculated position into a first area and a second area, decompressing the loaded data, and transferring the decompressed data to the upper layer.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional firmware upgrade method;

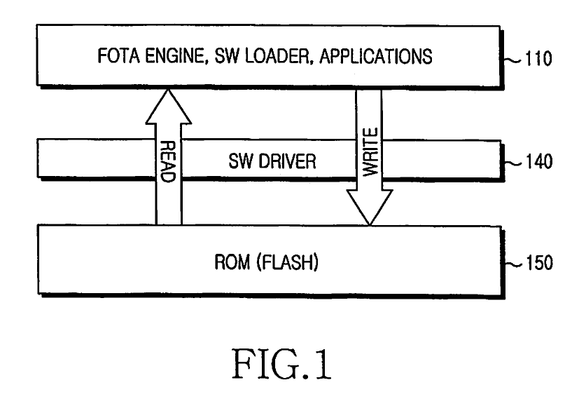

FIG. 2 is a block diagram of a firmware upgrade method according to an embodiment of the present invention;

FIG. 3 is a flowchart of a writing procedure of a virtual driver when a firmware is upgraded according to an embodiment of the present invention;

FIG. 4 is a flowchart of a reading procedure of a virtual driver when a firmware is upgraded according to an embodiment of the present invention;

FIGS. 5A and 5B are views of a virtual image of a storage unit provided by a virtual driver according to an embodiment of the present invention; and

FIG. 6 is a block diagram of a portable terminal having a firmware upgrade function according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A virtual driver performing a compression function and a decompression function is introduced to apply the compression function of a Firmware Over The Air (FOTA) technology.

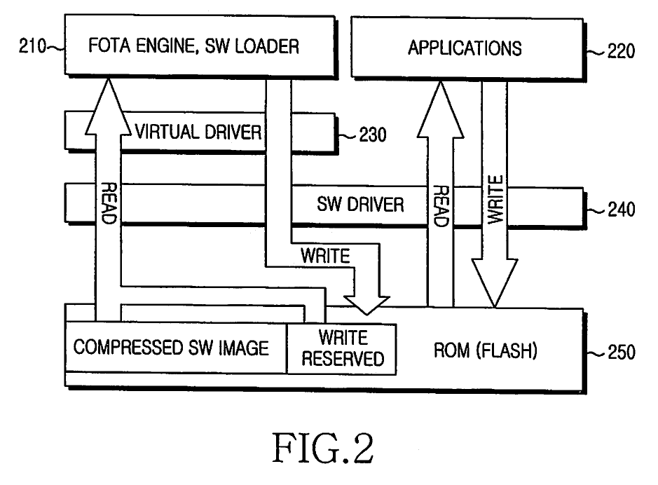

FIG. 2 is a block diagram of a firmware upgrade method according to an embodiment of the present invention.

In general, a software driver 240 has been operated between a FOTA engine 210 and applications 220 which are an upper layer of the software driver 240 and a memory 250 to access the memory 250.

However, according to the present invention, a virtual driver 230 is disposed between the software driver 240 and the upper layer to compress a firmware.

The virtual driver 230 loads its own driving code in the memory 250 to apply the compression function of a FOTA technology, but the virtual driver 230 does not have an influence on other functions.

That is, a memory access operation for performing other functions is the same as a conventional memory access operation. The memory 250 includes a software image (binary) compressed for FOTA technology and a write reserved area.

The write reserved area remains empty when an upgrade using FOTA technology is not performed, but the write reserved area stores changes of the software binary after the upgrade using FOTA technology is performed. The empty reserved area exists for preventing a shift operation in which all contents are shifted backwards after changing positions when a changed area is greater than an existing area in a compressed software binary area.

An upgrade time greatly increases when much of the software binary is moved. In addition, robustness characteristics that can securely restore data at any time when power is turned off disappears.

Generally, FOTA technology that deals with a uncompressed conventional software binary allocates vacant spaces, that is, holes in gaps of the uncompressed conventional software binary for buffering purpose. Hence, even if the changes are added to the uncompressed conventional software binary, the shift operation is prevented due to the holes. However, the holes do not exist in the compressed software binary to avoid the shift operation.

The shift operation can be prevented in case that the write reserved area is independently defined to upgrade the changes in the write reserved area without directly reflecting the changes on the software binary.

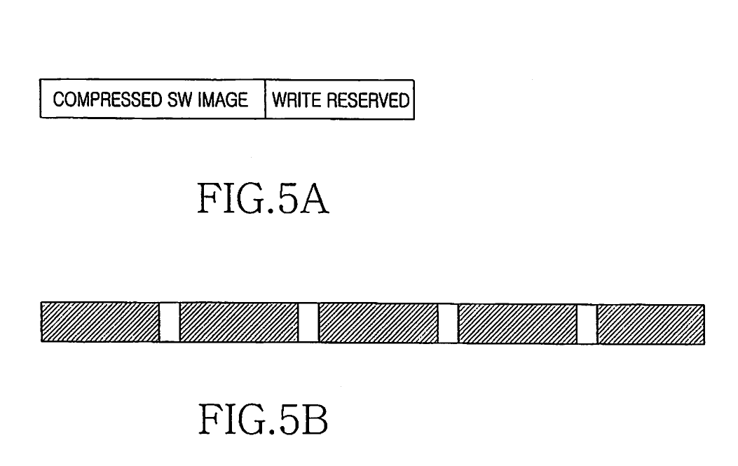

In this instance, an actual design of the virtual driver 230 is equal to that shown in FIG. 5A, but a virtual design of the virtual driver 230 is equal to that shown in FIG. 5B. To form the virtual driver 230, a mapping process and compression/decompression conversion processes are performed.

In a write operation, the software driver 240 intactly stores contents transferred by the virtual driver 230 in the memory 250. However, before this process starts, the virtual driver 230 compresses the transferred contents to transfer the compressed contents with position information to the software driver 240. After the compression process is finished, the virtual driver 230 determines whether information is stored only in the existing software binary or also the write reserved area. Then, the position information including the determined result is transferred to the software driver 240.

In a read operation, the software driver 240 intactly reads and transfers the contents contained in the memory 250 to the virtual driver 230. But the virtual driver 230 decompresses the transferred contents to transfer the decompressed contents to the upper layer. In case that the contents of a sector to be read in the read operation are previously stored in the write reserved area, the software driver 240 reads the contents not in the compressed software binary but in the write reserved area.

As described above, the software binary has been actually compressed, but it is considered that the software binary is not compressed in the upper layer due to the operations of the virtual driver 230. Therefore, processes relative to the memory 250 can be performed by the virtual driver 230 regardless of the compression of the memory 250 in the upper layer.

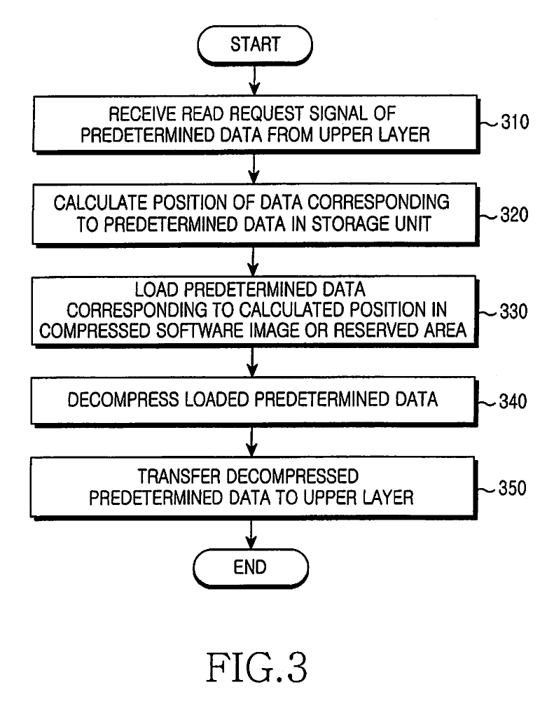

FIG. 3 is a flowchart of a writing procedure of a virtual driver when a firmware is upgraded according to an embodiment of the present invention.

In step 310, a virtual driver receives a read request signal of predetermined data from an upper layer.

In step 320, the virtual driver calculates a read position of data corresponding to the predetermined data in a storage unit (memory). The virtual driver determines whether the predetermined data exists only in software binary or also a write reserved area.

In step 330, the predetermined data is loaded in a compressed software image (or the software binary) or the write reserved area according to a calculated position.

In step 340, the loaded predetermined data is decompressed.

In step 350, the decompressed predetermined data is transferred to the upper layer. Thereafter, the process of the present invention is terminated.

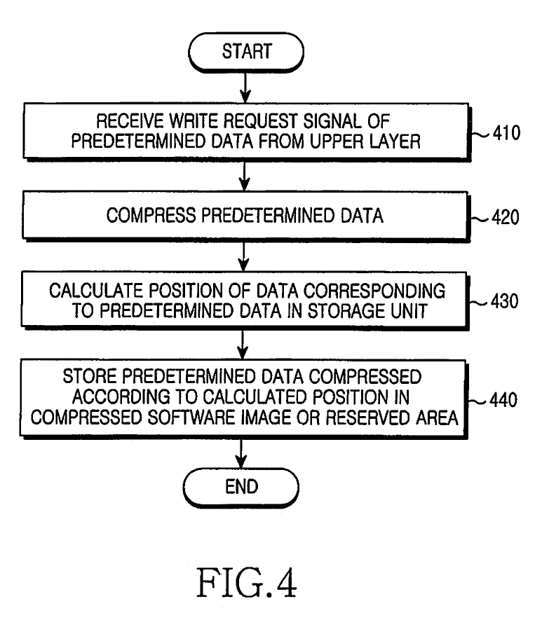

FIG. 4 is a flowchart of a reading procedure of a virtual driver when a firmware is upgraded according to an embodiment of the present invention.

In step 410, a virtual driver receives a predetermined data and a write request signal of the predetermined data from an upper layer.

In step 420, the predetermined data is compressed.

In step 430, the virtual driver calculates a write position of data corresponding to the predetermined data in a storage unit (memory). The virtual driver determines whether the predetermined data is written only in software binary or also a write reserved area.

In step 440, the compressed predetermined data is written in a compressed software image (or the software binary) or the write reserved area. Thereafter, the process of the present invention is terminated.

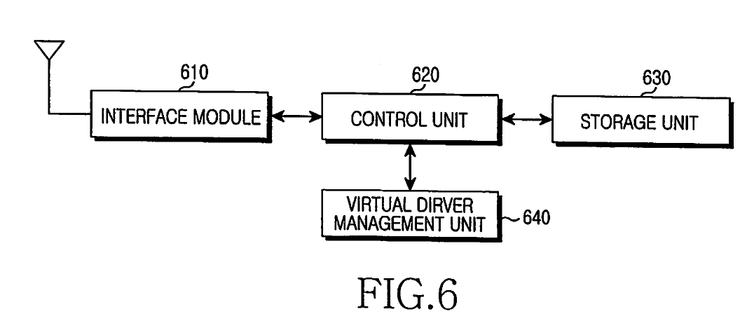

FIG. 6 is a block diagram of a portable terminal having a firmware upgrade function according to an embodiment of the present invention.

The portable terminal includes an interface module 610, a control unit 620, a storage unit 630, and a virtual driver management unit 640.

The interface module 610 is a module for communicating with other nodes and includes an RF processor and a baseband processor. The RF processor converts a signal received through an antenna into a baseband signal to provide the converted signal to a baseband processor. In addition, the RF processor converts a baseband signal from the baseband processor into an RF signal, which can be transmitted over air, and transmits the converted baseband signal to the antenna.

The control unit 620 processes and controls an overall operation of the portable terminal. For example, the control unit 620 processes and controls data communication. In addition to the general functions, the control unit 620 controls a virtual driver management unit 640 to apply a compression function of FOTA technology according to the present invention.

The storage unit 630 stores a program for controlling the overall operation of the portable terminal and temporary data generated during the execution of the program. In particular, according to the present invention, the storage unit 630 stores a compressed software image (software binary) and a write reserved area.

The virtual driver management unit 640 calculates a position according to a command and provided information of the control unit 620, and then decompresses the compressed software image (software binary) of the storage unit 630 or information stored in the write reserved area to transfer the decompressed image or information to an upper layer.

The virtual driver management unit 640 compresses information received from the upper layer to store the compressed information in the compressed software image (software binary) or the write reserved area.

Although the virtual driver management unit 640 is provided separately, the control unit 620 may perform some or all of the functions of the virtual driver management unit 640.

The virtual driver applies the compression function to the firmware upgrade method using FOTA technology, in which the conventional compression function is not applied, to reduce the necessary capacity of the memory without influencing the process using FOTA technology or differences between before and after the upgrade and the robustness characteristics.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A memory access method for firmware upgrade in a portable terminal, the method comprising:
receiving data and a write request signal of the data from an upper layer;
compressing the data; and
separating and storing the data in the first area and a second area when the capacity of the compressed data is greater than that of a first area of a memory.

2. The method of claim 1, wherein the first area is a compressed software image information storage area.

3. The method of claim 1, wherein the first area is a software binary information storage area.

4. The method of claim 1, wherein the second area is a reserved area.

5. A memory access method for firmware upgrade in a portable terminal, the method comprising:
receiving a read request signal of data from an upper layer;
calculating a position of the data;
loading the data corresponding to the calculated position into a first area and a second area;
decompressing the loaded data; and
transferring the decompressed data to the upper layer.

6. The method of claim 5, wherein the first area is a compressed software image information storage area.

7. The method of claim 5, wherein the first area is a software binary information storage area.

8. The method of claim 5, wherein the second area is a reserved area.

9. A portable terminal capable of firmware upgrade, the portable terminal comprising:
a control unit receiving data and a write request signal of the data from an upper layer and compressing the data, wherein the control unit separates and stores the data in a first area and a second area of a memory when the capacity of the compressed data is greater than that of the first area of the memory.

10. The portable terminal of claim 9, wherein the second area is a reserved area.

11. The portable terminal of claim 9, wherein the first area is a compressed software image information storage area.

12. The portable terminal of claim 9, wherein the first area is a software binary information storage area.

13. A portable terminal capable of firmware upgrade, the portable terminal comprising:
a control unit receiving a read request signal of data from an upper layer, calculating a position of the data, loading the data corresponding to the calculated position into a first area and a second area, decompressing the loaded data, and transferring the decompressed data after decompression.

14. The portable terminal of claim 13, wherein the second area is a reserved area.

15. The portable terminal of claim 13, wherein the first area is a compressed software image information storage area.

16. The portable terminal of claim 13, wherein the first area is a software binary information storage area.

17. A computer-readable recording medium having recorded thereon a program for memory access of firmware upgrade in a portable terminal, comprising
a first code segment for receiving data and a write request signal of the data from an upper layer;
a second code segment for compressing the data; and
a third code segment for separating and storing the data in the first area and a second area when the capacity of the compressed data is greater than that of a first area of a memory.

18. The computer-readable recording medium of claim 17, wherein the first area is a compressed software image information storage area.

19. The computer-readable recording medium of claim 17, wherein the first area is a software binary information storage area.

20. The computer-readable recording medium of claim 17, wherein the second area is a reserved area.
